(19) United States
(12) Patent Application Publication
(10) Pub. No.: US 2011/0300737 A1
(43) Pub. Date: Dec. 8, 2011

(54) CONTACTING PLUG AS WELL AS CONTACTING CONNECTION

(76) Inventors: Andreas Simmel, Schwaikheim (DE); Michael Schoenfeld, Leinfelden-Echterdingen (DE); Michael Fleig, Ra Tilburg (Nord-Brabant) (NL)

(21) Appl. No.: 13/140,217

(22) PCT Filed: Nov. 6, 2009
(86) PCT No.: PCT/EP09/64790

§ 371 Date: Aug. 23, 2011

(30) Foreign Application Priority Data
Dec. 19, 2008 (DE) 10 2008 054 983.5

(51) Int. Cl. H01R 13/62

(52) U.S. Cl. 439/370

(57) ABSTRACT

A contacting plug for contacting a contact carrier having two, at least approximately parallel surface sides, in particular a circuit board, two clamping claws able to be pivoted relative to each other, transversely to a plug-in direction, at least one of which is implemented as contact holder carrying at least one flexible contact element, which contact holder is designed to rest on the contact carrier with a contact force, and a spring for generating a clamping force which is independent of the contact force. An arrangement for the automatic parallelization of the clamping claws are provided, especially of contact surfaces of the clamping claws, with the surface sides of the contact carrier.

### FIELD OF THE INVENTION

The present invention relates to a contacting plug and contacting connection.

### BACKGROUND INFORMATION

One conventional contacting connection, which includes a contacting plug as well as a contacting plug receptacle, is described in German Patent Application No. DE 10 2005 063 239 A1. The conventional contacting connection is characterized by the fact that the contact forces applied by the contact elements on a circuit board are independent of clamping forces by which the clamping claws, which carry the contact elements and are developed as contact carriers, are resting against the circuit board. The clamping claws are configured such that, given a nominal dimension of the circuit board, they are aligned parallel to the circuit board. In other words, the contact surfaces formed on the clamping claws for contact with the contact carrier are aligned parallel to the circuit board. The conventional contacting plug has shown to be reliable. However, there appears to be room for improvement inasmuch as the clamping claws, or their contact surfaces, form an angle with the contact carrier when the contact carrier, especially the circuit board, has a maximum size (maximum tolerance), with the result that the contact surfaces are not resting on the circuit board surface-to-surface but via an edge. This causes undesired surface pressure in the region of the contact surface edges, for one, and it makes it impossible to ensure an optimal contacting of the circuit tracks or the lands of the contact carrier by contact elements of the contacting plug, for another.

### SUMMARY

The present invention relates to further developing the conventional contacting plug to the effect that an areal contact of the clamping claws on the contact carrier is ensured even at maximum dimensions of the contact carrier. Furthermore, the present invention relates to providing a contacting connection which includes a correspondingly improved contacting plug.

The framework of the present invention encompasses all combinations of at least two of the features describes in the specification and/or the figures.

The present invention is based on the idea of providing an arrangement for the automatic parallelization of the clamping claws with the face sides of the contact carrier, in order to ensure that the clamping claws are resting on the contact carrier in areal manner, preferably via corresponding contact surfaces, rather than along individual edges, this being the case even when the contact carrier has a maximum dimension (maximum thickness measurement). In other words, the clamping claws are assigned a mechanism that makes it possible for the clamping claws to pivot not only about a fixed axis, but which additionally allows a relative movement of the clamping claws with respect to each other, which movement is preferably oriented perpendicular to the plug-in direction, such that an areal contact of the contact surfaces of the clamping claws on the contact carrier is possible regardless of manufacturing tolerances in the thickness dimensions of the contact carrier. The fact that an areal contact of the contact surfaces on the contact carrier is able to be realized simultaneously allows an evenly distributed force introduction into the contact carrier, especially the circuit board, across all tolerances of the contact carrier, so that impermissible local surface pressures are avoided and reliable contacting of the circuit tracks or the lands of the contact carrier preferably developed as circuit board is ensured with the aid of the contact elements held by the contact holders.

In a further development of the present invention, in order to allow a movement that parallelizes the clamping claws with the contact carrier, the clamping claws are adjustable relative to each other along a translatory guide path, in particular a guide path imposed by a guide link. Preferably, the guide link is part of swivel joints, to be discussed later in the text, by which the clamping claws are connected, preferably to each other.

As previously mentioned, a specific development of the contacting plug is preferred in which the clamping claws are developed as separate components, which are connected to each other in articulated manner via at least one swivel joint, preferably via two swivel joints placed at a distance from each other, transversely to the plug-in direction. The separate implementation of the clamping claws allows for a simplified manufacture as plastic injection-molding component.

It is especially preferred if the at least one swivel joint is developed in such a way that it allows an adjusting movement of the clamping claws relative to each other, perpendicular to a swivel axis, or such that the swivel axis is able to be shifted in parallel. For this purpose a previously mentioned guide link is preferably integrated into the swivel joint, which specifies a movement direction that is oriented perpendicular to the swivel axis. The guide link may be implemented as elongated hole joint component, with which a joint component, preferably having a part-spherical shape at the extremity, of the respective other clamping claw engages in form-fitting manner. It is especially preferred if the swivel joint is developed to resemble swivel joints in waffle irons (waffle iron principle) and allows two terminal regions of the clamping claws to move away from each other when the other two end sides of the clamping claws are simultaneously moved toward each other, in this case, with the aid of a spring force. In other words, the at least one swivel joint is implemented with an additional degree of freedom compared to known swivel joints.

It is especially preferred if the swivel joint is formed by two joint sections which are disposed on the clamping claws in distributed manner, the joint sections being integrally formed with the associated clamping claw, for instance by injection molding. To realize a connection-link guidance, it is especially preferred if one of the joint sections is implemented as elongated hole, which allows a relative displacement of the clamping claws away from each other in the region of the swivel joint.

In order to reduce the outlay in connection with stock keeping and logistics, the clamping claws are preferably developed as non-variable parts, which also facilitates the production.

Especially preferred is a development of the contacting plug in which the at least one contact surface provided on the contact holder for the immediate, i.e., direct, bracing on the contact carrier is implemented and disposed in such a way that it supports itself on at least one circuit track and/or at least one land of the contact carrier, so that thickness tolerances of the circuit tracks or lands are thereby able to be compensated in an optimal manner. According to the previously described further development, the contact surface thus is not resting in a region next to the circuit tracks and/or lands on the contact carrier, but directly on at least one circuit track and/or at least one land.

In one further development of the present invention, the contact surface is advantageously disposed between two receiving trenches for one of the contact elements in each case, and preferably developed in such a way that it supports itself simultaneously on two circuit tracks or lands adjacent to each other transversely to the plug-in direction.

Especially preferred is a development in which the contacting plug is developed as autonomous with respect of the magnitude of the clamping force at which the clamping claws, preferably implemented as contact holders, are resting on the contact carrier, especially a circuit board. In other words, the clamping force of the contacting plug acting on the clamping claws is at least approximately, preferably completely, independent of the form of the contacting plug receptacle. This is preferably achieved in that the spring in the final installation state of a contacting connection provided with a contacting plug, that is to say, with a contacting plug accommodated in the contacting plug receptacle, no longer support themselves on the contacting plug receptacle in order to generate the clamping force, as is the conventional case, but solely on the contacting plug.

In other words, the spring engages with the contacting plug exclusively, preferably with clearance from the swivel joints, such that the clamping claws, at least one if which is developed as contact holder supporting at least one flexible contact element, have a tendency to move towards each other. In still other words, the spring, which braces itself solely on the contacting plug, preferably solely on the clamping claws, in order to generate the clamping force, opposes an opening movement of the clamping claws forced during a plug-in operation. Since the clamping force in a contacting plug developed as previously described is no longer dependent on a form change or relaxation of the contacting plug receptacle, a drop below a minimally required clamping force is advantageously avoided. Furthermore, the structure is able to be simplified due to the special form and placement. Another advantage is that the clamping force is able to be generated even without providing a contacting plug receptacle, so that the provision of such a receptacle may be dispensed with from case to case.

In one further development of the present invention, the spring is advantageously developed and placed in such a way that the clamping force generated by the spring and the contact force generated by the at least one flexible contact element lie in one working plane. In other words, in a force arrow model, the force arrows of the previously mentioned forces lie in one plane. For example, this may be achieved by placing the spring directly outside contact points at which the contact elements are resting on the contact carrier, especially on lands or circuit traces of a circuit board.

It is especially preferred if the contacting plug is designed to interact with at least one mating plug-in element which tensions the spring when the contacting plug is plugged in. The mating plug-in element is preferably part of a contacting plug receptacle mentioned in the introduction, and is inserted into a corresponding receptacle (receiving channel) of the same when plugged in, and causes the clamping claws to widen during the insertion process, i.e., relative swiveling of the clamping claws toward each other, about the at least one swivel joint, which in turn results in tensioning of the spring.

In one further development of the present invention, the spring advantageously is of a peripherally closed configuration, i.e., form a ring, which preferably has a rectangular contour, in particular, which surrounds the clamping claws, preferably in a transverse direction to their longitudinal extension. In other words, the spring fully encloses the clamping claws and applies a spring force to the clamping claws in a direction toward one another.

It is especially useful if the spring includes at least two, preferably exclusively two, preferably identical spring elements, which are developed especially as wire spring elements, are in operative connection with each other and preferably connected to each other in form-fitting manner; a development in which the spring is implemented as helical or spiral spring, which preferably exerts tensile stress on the clamping claws, also is possible. In addition or as an alternative, the use of spring means made from an elastomer material is possible as well.

The present invention also leads to a contacting connection having a previously described contacting plug able to be plugged into a contacting-plug receptacle, which is assigned to a contact carrier, especially a circuit board, and preferably fastened to it. In this context it is especially preferred if the contacting plug is resting directly on at least one circuit track or a land via at least one contact surface, preferably simultaneously on two circuit tracks or two lands, or on one circuit track and one land of the contact carrier, in order to be able to compensate manufacturing tolerances of the circuit track or land in this manner. The contacting connection preferably is an electrical direct plug-in connection for contacting circuit boards in control devices and/or components, especially for door control devices and/or engine control devices in motor vehicles.

### BRIEF DESCRIPTION OF THE DRAWINGS

Additional advantages, features and details of the present invention may be derived from the description of preferred exemplary embodiments below as well as from the figures.

FIG. 1 shows a schematic, incomplete representation of a contacting plug.

FIG. 2 shows a perspective view of a contacting plug, the illustration of a preferably provided installation aid housing being dispensed with.

FIG. 3 shows a sectional view of the contacting plug according to FIG. 2.

FIG. 4 shows two clamping claws for a contacting plug, which are developed as non-variable parts.

FIG. 5 shows a contact carrier in a schematic sectional view, the contact carrier having bilaterally disposed circuit tracks, on which electrically non-conductive contact surfaces of the clamping claws are resting directly.

### DETAILED DESCRIPTION OF EXAMPLE EMBODIMENTS

Identical elements and elements that have the same function have been provided with matching reference numerals in the figures.

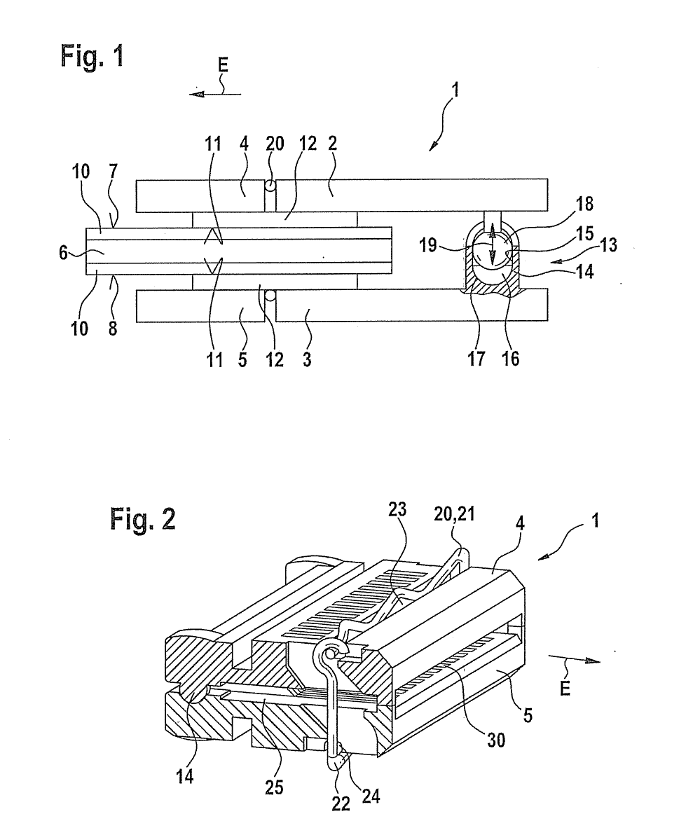

FIG. 1 shows an incomplete representation of a contacting plug 1. For reasons of clarity, the illustration of a housing used as installation aid and of the contacting receptacle accommodating the contacting plug has been omitted. With the aid of two clamping claws 4, 5 developed as contact holders 2, 3, contacting plug 1 is clamping a contact carrier 6 implemented as circuit board. A multitude of circuit tracks 10 is situated on contact carrier 6 on both surface sides 7, 8 (flat sides) which run parallel to each other, only one circuit track 10 being shown per surface side 7, 8 in the sectional view according to FIG. 1.

Contact holders 2, 3 carry metallic contact elements (not shown) for contacting circuit tracks 10, the contact elements connecting circuit tracks 10 with connecting lines (not shown) of a cable tree in electrically conductive manner. The contact forces by which the contact elements rest against contact carrier 6 are independent of clamping forces by which clamping claws 4, 5 are pressed against contact carrier 6. This is due to the provision of contact surfaces 11, with whose aid clamping claws 4, 5 brace themselves on contact carrier 2, more precisely, directly on circuit tracks 10. Contact surfaces 11 are disposed on projections 12 integrally formed with clamping claws 4, 5, which projections project in the direction of contact carriers 6.

An arrangement 13 for the automatic parallelization of clamping claws 4, 5, more precisely, contact surfaces 11, relative to surface sides 7, 8 of contact carrier 6 implemented as circuit board are assigned to clamping claws 4, 5. The arrangement 13 enables clamping claws 4, 5 or contact surfaces 11 to (automatically) align themselves parallel to surface sides 7, 8, regardless of the thickness dimension (within a tolerance range) of contact carrier 6. This ensures that clamping claws 4, 5, more precisely, contact surfaces 11, rest in areal manner, and not merely along end edges, on contact carrier 6 or surface sides 7, 8, more precisely, on circuit tracks 10.

The arrangement 13 for parallelization includes swivel joints 14 at the extremities, with whose aid clamping claws 4, 5, which are implemented as separate components, are able to swivel relative to each other about a swivel axis that runs perpendicular to a plug-in direction E, that is to say, into the drawing plane in the illustration according to FIG. 1.

Swivel joints 14 include an elongated hole 16 implemented as guide link 15, guide link 15 or elongated hole 16 in each case being formed by a first joint section 17 of lower clamping claw 5 in the drawing plane. First joint section 17 having guide link 15 is used as a kind of joint socket, in which a second joint section 18 is accommodated, which is integrally formed with upper clamping claw 5 in the drawing plane. The joint construction not only allows swiveling of clamping claws 4, 5 relative to each other, about the previously mentioned swivel axis situated perpendicular on the drawing plane, but also an adjustment movement of clamping claws 4, 5 relative to each other in arrow directions 19, by which contact surfaces 11 align themselves automatically parallel to surface sides 7, 8 of contact carrier 6. In so doing, the swivel axis is displaced in parallel.

Furthermore, it can be gathered from FIG. 1 that clamping claws 4, 5 are acted upon by a spring force in a direction towards each other, with the aid of spring 20, which are of a peripherally closed configuration and brace themselves solely on contacting plug 1 so as to generate the clamping force.

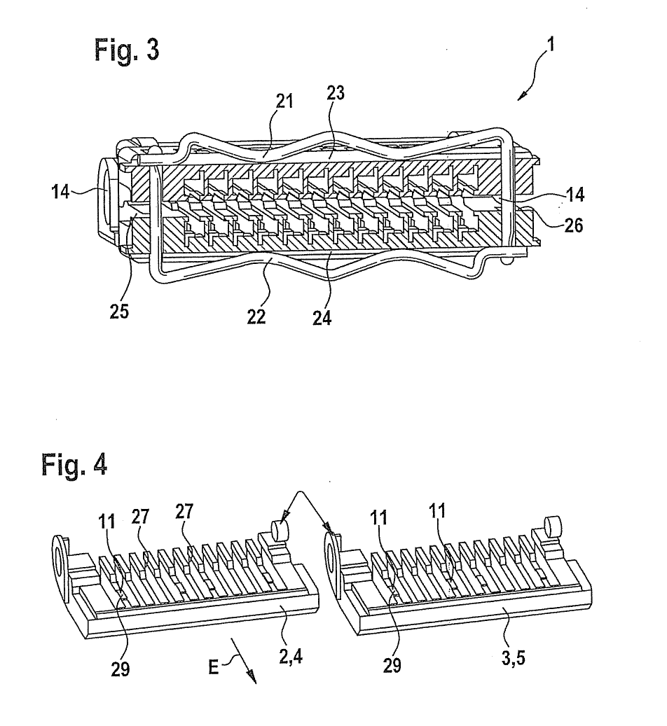

As can be gathered from the illustrations according to FIGS. 2 and 3, contacting plug 1 includes two identically developed clamping claws 4, 5, which are disposed in mirror symmetry, both clamping claws 4, 5 in the illustrated exemplary embodiment being implemented as contact holders 2, 3 for carrying a multitude of contact elements 30. Contact elements 30 are spring elements made of metal and developed analogous to those described in German Patent Application No. DE 10 2005 063 239 A1, for example. They are employed for the direct contacting of the contact carrier (not shown) or of circuit tracks or lands (not shown) of the contact carrier. Male multipoint connectors are intentionally dispensed with in this case. The contact forces at which the contact elements are resting on the circuit tracks or lands are independent of a clamping force at which clamping claws 4, 5 brace themselves on the contact carrier.

The previously already mentioned spring 20, which, as can be gathered from FIGS. 2 and 3, is made up of two spring elements 21, 22 implemented as wire spring elements, are provided to generate the clamping force. They are connected to each other by form-fitting and developed as non-variable parts in order to minimize production costs and to simplify the installation. As can be gathered from FIG. 3, spring elements 21, 22 implemented as wire spring elements lock into each other and thus form spring 20 having a peripherally closed configuration. In other words, spring elements 21, 22 form an annular spring element, which applies a spring force to clamping claws 4, 5 in a direction toward each other.

Clamping claws 4, 5 are connected to each other in pivotable manner via hinges 14, which are not shown in detail and are implemented analogous to the exemplary embodiment according to FIG. 1, for example.

As can be gathered from an overall view of FIGS. 2 and 3, spring 20 is accommodated in grooves 23, 24 extending transversely to the longitudinal extension of contacting plug 1, which grooves guide spring 20. Spring elements 21, 22 sectionally engage with these grooves 23, 24, grooves 23, 24 being disposed in such a way that they are located in one plane with the contact points (not shown) against which contact elements 30 are resting on surface sides 7, 8 of contact carrier 6 (not shown) from both sides.

As can additionally be gathered from FIG. 3, spring elements 21, 22 have a rippled or serrated design on the upper side and on the lower side of contacting plug 1 and rest on clamping claws 4, 5 at defined points in grooves 23, 24, which points are set apart from each other transversely to the longitudinal extension of contacting plug 1, or transversely to plug-in direction E. In the illustrated exemplary embodiment, grooves 23, 24 have a generally cylindrical contour in cross-section, but a contouring of grooves 23, 24 having a rectangular, trapezoidal or triangular cross-section is realizable as well.

As can be gathered from FIGS. 2 and 3, a receiving channel 25, 26 is provided on each longitudinal side of contacting plug 1, which channel is delimited by clamping claws 4, 5 and extends in plug-in direction E. Receiving channels 25, 26 accommodate a mating plug-in element (not shown), which has leading slants and may be developed and placed in the manner described in German Patent Application No. DE 10 2005 063 239 A1. The mating plug-in elements have the previously mentioned leading slants and thus ensure that clamping claws 4, 5 swivel relative to each other about swivel joints 14 when being inserted in the contacting-plug receptacle (not shown), the spring being tensioned in this swivel operation, and clamping claws 2, 3 having a spring force applied in a direction toward each other.

FIG. 4 shows the two clamping claws 4, 5 implemented as non-variable parts and used or implemented as contact carriers 2, 3. They include a multitude of adjacently disposed receiving trenches 27, which extend in plug-in direction E and accommodate the contact elements (not shown) developed as metal springs. Two receiving trenches 27, positioned next to each other in each case, are separated from each other by segments 28, which likewise run in plug-in direction E.

As can furthermore be gathered from FIG. 4, a projection 29 is provided on some segments 28, which extends in the direction of the contact carrier (not shown). The surfaces of these projections 29 form the aforementioned contact surfaces 11 via which clamping claws are resting directly on circuit tracks. Contact surfaces 11 are developed and placed in such a way that clamping claws 4, 5 directly brace themselves on two circuit tracks in each case via each contact surface 11.

The arrows in the illustration according to FIG. 4 show the locations where clamping claws 4, 5, or the swivel joints obtained thereby, are to be mated.

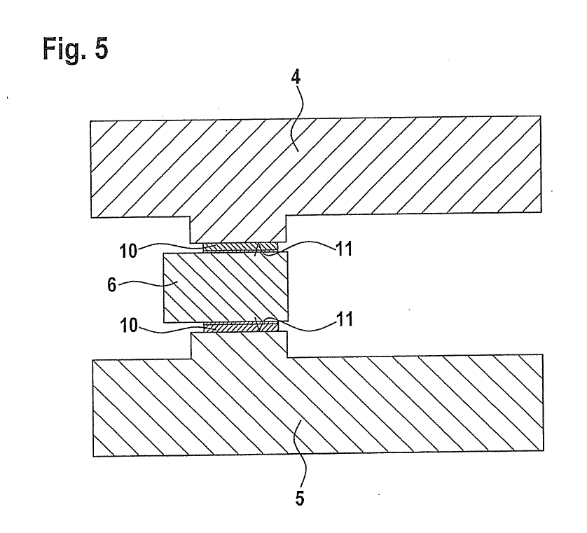

The illustration according to FIG. 5 shows that clamping claws 4, 5 are braced via contact surfaces 11 directly on circuit tracks 10 of contact carrier 6, which is implemented as circuit board, thereby compensating not only for manufacturing tolerances in the thickness dimension of the actual contact carrier, but also for manufacturing tolerances in the thickness or height dimensions of circuit tracks 10.

1-15. (canceled)

16. A contacting plug for contacting a contact carrier having two approximately parallel surface sides, the contacting plug comprising:
two clamping claws which are able to be pivoted relative to each other transversely to a plug-in direction, at least one of the clamping claws being implemented as a contact holder carrying at least one flexible contact element, the contact holder being configured to rest on the contact carrier with a contact force;
a spring to generate a clamping force that is independent of the contact force; and
an arrangement for automatic parallelization of contact surfaces of the clamping claws with the surface sides of the contact carrier.

17. The contacting plug as recited in claim 16, wherein the contact carrier is a circuit board.

18. The contacting plug as recited in claim 16, wherein the clamping claws are adjustable relative to each other along a translatory guide path a guide link.

19. The contacting plug as recited in claim 16, wherein the clamping claws are autonomous components which are connected to one another via at least one swivel joint.

20. The contacting plug as recited in claim 19, wherein the swivel joint is configured to allow an adjustment movement of the clamping claws relative to each other, perpendicular to a swivel axis.

21. The contacting plug as recited in claim 19, wherein the swivel joint includes two joint sections which are disposed in distributed manner on the clamping claws and integrally formed therewith, one of the joint sections having an elongated hole.

22. The contacting plug as recited in claim 16, wherein the clamping claws are non-variable parts.

23. The contacting plug as recited in claim 16, wherein at least one contact surface disposed on the at least one contact holder defines a position of the contact element relative to the contact carrier and is positioned so as to rest on at least one of a circuit track and land of the contact carrier.

24. The contacting plug as recited in claim 16, wherein the contact surface is situated between two receiving trenches for one of the contact elements in each case.

25. The contacting plug as recited in claim 16, wherein the spring is configured to brace solely on the contacting plug to generate the clamping force.

26. The contacting plug as recited in claim 16 wherein the spring is configured and disposed in such a way that the contact force and the clamping force lie in a common working plane.

27. The contacting plug as recited in claim 16, wherein the contacting plug is configured to interact with a mating plug-in element which tensions the spring when the contacting plug is plugged in.

28. The contacting plug as recited in claim 16, wherein the spring has a peripherally closed configuration.

29. The contacting plug as recited in claim 16, wherein the spring includes at least two identical spring elements implemented as wire spring elements, which are in operative connection with each other.

30. A contacting connection, comprising:
a circuit board; and
a contacting plug configured to be plugged into a contact receptacle of the circuit board, the contacting plug include two clamping claws which are able to be pivoted relative to each other transversely to a plug-in direction, at least one of the clamping claws being implemented as a contact holder carrying at least one flexible contact element, the contact holder being configured to rest on the contact carrier with a contact force, the contacting plug further including a spring to generate a clamping force that is independent of the contact forces, and an arrangement for automatic parallelization of contact surfaces of the clamping claws with surface sides of the circuit board.

31. The contacting connection as recited in claim 30, wherein the contacting plug rests via at least one contact surface on at least one of a circuit track and one land of the contact carrier.
